(19) United States
(12) Patent Application Publication
(10) Pub. No.: US 2025/0033930 A1
(43) Pub. Date: Jan. 30, 2025

(54) METHOD FOR ENSURING ELEVATOR SAFETY IN ELEVATOR SYSTEM, ELEVATOR CONTROL UNIT, ELEVATOR SYSTEM, AND COMPUTER PROGRAM PRODUCT

(71) Applicant: KONE Corporation, Helsinki (FI)

(72) Inventors: Tapani TALONEN, HELSINKI (FI); Ari KATTAINEN, HELSINKI (FI); Juha-Matti AITAMURTO, HELSINKI (FI); Aki HAIKONEN, HELSINKI (FI); Tapio SIIRONEN, HELSINKI (FI); Ville MYYRYLÄINEN, HELSINKI (FI)

(73) Assignee: KONE Corporation, Helsinki (FI)

(21) Appl. No.: 18/915,732

(22) Filed: Oct. 15, 2024

Related U.S. Application Data
(63) Continuation of application No. PCT/FI2022/050270, filed on Apr. 26, 2022.

(51) Int. Cl. B66B 5/02; B66B 5/00

(52) U.S. Cl. CPC B66B 5/021; B66B 5/0031; B66B 2201/40

(57) ABSTRACT

A method for ensuring elevator safety in an elevator system, an elevator control unit, an elevator system, and a computer program product are disclosed in this document. The method comprises detecting a foreign object in an elevator shaft during normal operation mode, establishing a safe zone of the elevator shaft, wherein the safe zone is associated with a safe zone speed, a safe distance, and a safe direction, switching operational mode of the elevator system to a safe zone mode, determining that the elevator car is in the safe zone, and allowing movement of the elevator car in the safe zone to the safe direction at a speed not exceeding the safe zone speed.

### FIELD OF THE INVENTION

The present invention relates in general to elevators. In particular, however not exclusively, the present invention concerns methods and systems for ensuring elevator safety.

### BACKGROUND

There are elevators which have a short headroom, or top, and/or a short pit, or bottom, of the elevator shaft. In such elevators, elevator maintenance operations, such as related to service and inspection, for components in the shaft are made from inside elevator car, for example, through an opened car service access roof, floor, or walls, or through opened car doors. In these cases, the permanent and natural refuge spaces are provided inside the elevator car as there is no free headroom space nor refuge space on the top of car and/or free pit space on the bottom of the shaft. The car inspection drive can thus be performed from inside the elevator car with opened car roof as the service access to the shaft typically above (or below or side) the car.

In case of elevators with no headroom, the access from a landing to the top of car can be disabled or prevented by removing an emergency opening devices from landing doors (excluding the lowest landing door, for instance) and by having enhanced vandal protection in the landing doors so that it is not possible to manipulate them to open if elevator car is not at a landing. For the residual risk of shaft intrusion and foreign objects in the shaft, a detection system can be utilized on the elevator car roof which detects if there is a person on the roof of the elevator car.

There are several known solutions for such detections system, such as curtain of light type optical detection system, detection by swinging roof panels based on a switch, floating detection platform plate based on a switch, and pressure sensitive detection carpet on the roof of the elevator car.

If the detection system indicates presence detection when the elevator is running, the elevator performs an immediate emergency stop. This is, of course, due to the fact that there is no free space in top and according to the detection system, there is person on the top of car which is potentially a dangerous situation.

In practice, it is not possible to get access to the top of a moving elevator car but there is always a small risk that the detection system indicates detection for other reasons, such as due to a reliability problem related to the detection or some other object on the car roof, for example, a rat or bird, or smoke in case of curtain of light detection system. The result of this can be that passengers become trapped or stuck inside the elevator car if it stops between the landings and/or door zone areas.

In case of detecting a person on the elevator car roof, in a known solution, all movement of the elevator car is being disabled, for example, by triggering an anti-creep device. This can result in a very long waiting time for the passengers until a licensed maintenance technician arrives at the site to drive the elevator car to the next landing by rescue drive function.

### SUMMARY

An objective of the present invention is to provide a method for ensuring elevator safety in an elevator system, an elevator control unit, an elevator system, and a computer program product. Another objective of the present invention is that the method, the elevator control unit, the elevator system, and the computer program product method at least alleviate the drawbacks in the known solutions, such as related to prolonged time that the passengers are trapped inside the elevator car.

The objectives of the invention are reached by a method for ensuring elevator safety in an elevator system, an elevator control unit, an elevator system, and a computer program product as defined by the respective independent claims.

According to a first aspect, a method for ensuring elevator safety in an elevator system is provided. The method comprises the following steps:
detecting a foreign object in an elevator shaft during normal operation mode,
establishing a safe zone of the elevator shaft, wherein the safe zone is associated with a safe zone speed, a safe distance, and a safe direction,
switching the operational mode of the elevator to a safe zone mode, and
allowing movement of the elevator car in the safe zone to the safe direction at a speed not exceeding the safe zone speed.

Term “foreign object” as used herein refers to any physical object, such as a person, an animal, an open hatch which has been opened into the elevator shaft, or other physical object which is detectable, for example, by sensors, as being present inside the elevator shaft and outside the elevator car, however, which should not be there during the normal operation mode of the elevator system. Therefore, the foreign object is an object which presence in the elevator shaft is undesired during the normal operation mode, especially due to safety reasons. Thus, the foreign object may be part of the elevator system (such as a hatch) or an external object relative to the components of the elevator system.

Term “normal operation mode” as used herein refers to operational mode of the elevator system in which the elevator car(s) serve(s) landing floors in normal manner, that is responding to elevator commands/calls. In the normal operation mode, at least critical safety systems are functional so that safety of the users is at a sufficiently high level. In the normal operation mode, the safety chain circuit of the elevator system is intact/error-free. As known to a skilled person, the safety chain circuit typically includes, for example, a plurality of protection devices.

In various embodiments, the safe zone may be established based on a position of the elevator car, such as with respect to safe direction of the car, or with respect to size of the safe zone with respect relative to the position of the elevator car. Furthermore, the position of the elevator car close to an end of the elevator shaft may utilized to define the safe zone.

The safe zone speed may be equal to or less than the elevator's maintenance mode or correction drive speed.

In addition or alternatively, the safe direction may be away from the direction in which detection of a foreign object or an open car hatch has been indicated.

Still additionally or alternatively, the safe distance may be that between the car and a landing that is closest to the car in the safe direction.

Furthermore, the safe zone may include at least one landing or landing floor position in the safe zone.

In various embodiments, the safe zone may be delimited by a limit switch device arranged to the elevator shaft.

In various embodiments, a mechanical safety limit device may be arranged to prevent the elevator car moving in the direction towards the shaft end upon or after exiting the safe zone in the direction of the shaft end. Alternatively or in addition, the method may comprise pre-triggering an extendable safety limit device, such as arranged to an elevator car, in response to the switching of the operational mode of the elevator to the safe zone mode.

In various embodiments, the method may comprise, after allowing movement, automatically moving the elevator car to a landing in the safe zone that is closest to the elevator car. Furthermore, the method may optionally further comprise, after the automatically moving, opening of elevator car doors.

Furthermore, the method may comprise, prior to the allowing movement, determining that the elevator car is in the safe zone.

In some embodiments, the detection of the possible foreign object is based on detecting an foreign object outside the elevator car, such as by a sensor or switch. Alternatively or in addition, the detection of the possible foreign object is based on detecting an open hatch condition of the elevator car, such as by a switch arranged to monitor the status of the hatch.

In some embodiments, the method may comprise, prior to the allowing movement, determining that the possible foreign object is not detected anymore.

According to a second aspect, an elevator control unit is provided. The elevator control unit comprises at least one processor and at least one memory, such as a non-transitory or non-volatile memory device, storing at least one portion of computer program code, wherein the elevator control unit is configured to control movement of an elevator car. Furthermore, the elevator control unit is configured to perform a method in accordance with the first aspect.

According to a third aspect, an elevator system is provided. The elevator system comprises at least one elevator car, each one of the at least one elevator car movable in a corresponding elevator shaft, and at least two landings. The elevator system further comprises the elevator control unit in accordance with the second aspect.

In various embodiments, the elevator shaft may be arranged to comprise a low top. Alternatively or in addition, the elevator shaft may be arranged to comprise a low pit.

According to a fourth aspect, a computer program product is provided. The computer program product comprises program instructions, such as being stored in a non-transitory or non-volatile memory medium, which when executed by an elevator control unit cause the elevator control unit to perform the method in accordance with the first aspect.

The present invention provides a method for ensuring elevator safety in an elevator system, an elevator control unit, an elevator system, and a computer program product. The present invention provides advantages over known solutions in that it enables the movement of an elevator car in a condition related to a situation in which there is/are detection(s) of foreign object(s) in the elevator shaft and outside the elevator car. The enabling of the movement of the elevator car may allow movement to the closest landing and performing rescuing of passengers in case of activated detection of person in the elevator shaft.

Various other advantages will become clear to a skilled person based on the following detailed description.

The terms “first”, “second”, etc. are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an elevator system according to an embodiment of the present invention.

FIG. 2 illustrates schematically an elevator system according to an embodiment of the present invention.

FIG. 3 illustrates schematically an elevator system according to an embodiment of the present invention.

FIG. 4 shows a principle of electrical safety control for safe zone according to an embodiment of the present invention.

FIG. 5 shows a flow diagram of a method according to an embodiment of the present invention.

FIG. 6 shows a flow diagram of a method according to an embodiment of the present invention.

FIG. 7 illustrates schematically an elevator control unit according to an embodiment of the present invention.

### DETAILED DESCRIPTION OF SOME EMBODIMENTS

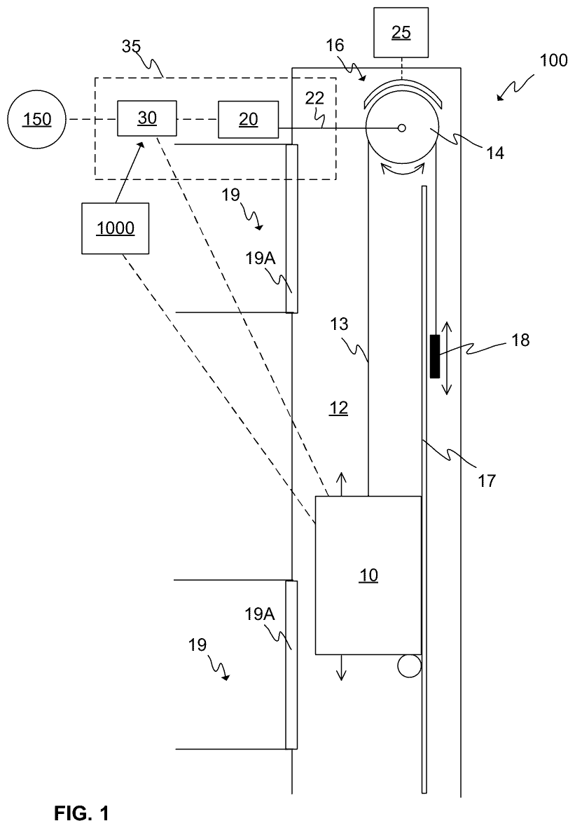

FIG. 1 illustrates schematically an elevator system 100 according to an embodiment of the present invention. The elevator system 100, or as visible in the figure, an elevator 100 or one of the elevators of the system 100, may comprise an elevator car 10 arranged to be moved or movable in an elevator shaft 12. The moving of the elevator car 10 may be implemented, for example, by a hoisting rope or belt 13 in connection with a traction sheave 14 or the like, by hydraulics, or by a linear motor. Furthermore, the elevator 100 comprises an electric motor 20 arranged to operate, such as rotate by the rotor thereof, the traction sheave 14 for moving the elevator car 10, if not essentially directly coupled to the hoisting rope 13. The traction sheave 14 may be connected, via a mechanical connection 22, directly or indirectly via a gear to a shaft of the motor 20. The elevator 100 may comprise a machine room or be machine roomless, such as have the motor 20 in the elevator shaft 12.

The elevator 100 may preferably comprise landings 19 or landing floors and, for example, landing floor doors 19A and/or openings, between which the elevator car 10 is arranged to be moved during the normal elevator operation, such as to move persons and/or items between said landings 19.

In various embodiments, the elevator shaft 12 may be such that when the elevator car 10 is at the bottom and/or top landing 19, there is essentially no space in the shaft 12 for, for example, maintenance personnel to operate. Such an elevator 100, in which both the bottom and top landings 19 are essentially without free space, may be referred to as a Low Pit Low Headroom elevator. In some embodiments, the height of the pit, that is the bottom portion of the shaft 12, and/or the headroom, that is the top portion of the shaft 12, may be, for example, less than or equal to 2.5 meters or less than 1.5 meters, or even less than 1 meter.

The elevator 100 may preferably comprise at least one hoisting machinery brake(s) 16 configured for resisting or, preferably, preventing the movement of the motor 20, that is the rotor thereof, directly or via the traction sheave 14 or components thereof and/or therebetween. Furthermore, the elevator 100 may comprise a brake controller 25 configured to operate at least one of the at least one hoisting machinery brake 16. The brake controller 25 may further be in connection with other elements of the elevator 100, such as an elevator control unit 1000. The brake controller 25 may comprise an actuator (not shown) for operating the brake 16 or at least be in connection with such an actuator.

There may additionally be, at least in some embodiments, a counterweight 18 arranged in connection with the elevator car 10 such as is known to a person skilled in the art of elevators. Still further, the elevator 100 may additionally comprise a guide rail 17 or rails 17 arranged into the elevator shaft 12 for guiding the movement of the elevator car 10. The elevator car 10 may comprise guide shoes, rollers or the like in moving in contact with the guide rails 17.

The elevator system 100 may further comprise an elevator drive unit 35, such as comprising at least a converter unit 30 and preferably the elevator motor 20. The elevator drive unit 35, such as the converter unit 30 thereof, may comprise an input for receiving absolute position and speed information of an elevator car 10, such as from an encoder mounted to the elevator car 10 or to the elevator motor 20, and a processing unit configured to calculate a motion profile of an elevator car 10. The elevator car 10 may be configured to be driven by the elevator drive unit 35 according to the motion profile. The motion profiles may differ based on, for example, whether the elevator system 100 is in normal operation conditions or in a safe zone condition.

Furthermore, the converter unit 30 may comprise, or substantially be, an inverter or a frequency converter, for connecting to, and controlling the operation of, the motor 20, and a controller in connection with the converter unit 30, wherein the controller is configured to operate the converter unit 30 to provide electrical power (signals), such as having variable voltage and variable frequency, to the windings of the motor 20. The controller may be a separate controller device or be comprised in the converter unit 30, for instance. The converter unit 30 may be disposed in the elevator shaft 12.

Still further, the converter unit 30 may be arranged to be fed by an electrical power source 150 for example from an external electrical power grid or mains power supply, or a backup power source, for example, a battery system.

In various embodiments, the elevator 100 comprises an elevator control unit 1000. The elevator control unit 1000 may be disposed in a door frame of a landing 19 or in a landing door frame. The elevator control unit 1000 may be configured to receive service requests from elevator passengers, such as via an elevator call request system, and calculate a motion profile for the elevator car 10 to serve the service requests. The converter unit 30 controls elevator hoisting machine such that elevator car speed is in accordance with the motion profile.

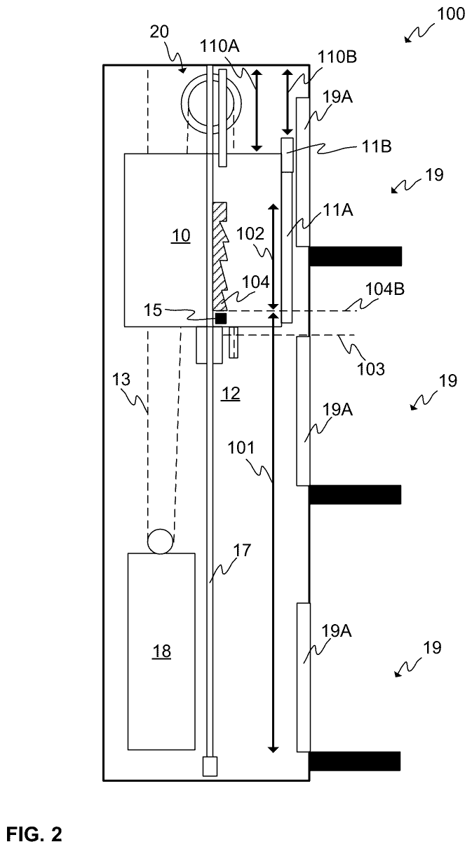

FIG. 2 illustrates schematically an elevator system 100 according to an embodiment of the present invention. There is arranged a safe zone 101 in relation to positions of the elevator car 10 in the elevator shaft 12, such as extending along the longitudinal direction of the shaft 12. The elevator system 100 is configured to allow movement of the elevator car 10, after detection of foreign object in the elevator shaft 12 (there may or may not have been performed an emergency stop), at a safe speed, e.g. 0.3 m/s, or an inspection or correction drive speed defined for and/or used when the elevator 10 is in the maintenance operation mode, preferably not exceeding the safe (or inspection or correction) speed, and for a safe distance, e.g. to the next landing, to a safe direction, for example, downwards in case of detecting presence of a foreign object on car roof and reduced/missing free space in the top portion of the elevator shaft 12, that is the elevator or elevator system 100 comprises a low top or headroom. The elevator emergency stop may be initiated if car top detection (CTD) indicates presence detection or car roof open monitoring (ROM) indicates car roof opening. Furthermore, FIG. 2 illustrates an elevator car door 11A and an elevator car door operating device 11B.

When an elevator car 10 is in the safe zone 101, there is sufficient free space 110A and clearances 110B at the end, in case of FIG. 2 the top, of the shaft 12. If the car 10 is not in the safe zone 101, that is in non-safe zone 102, or in general, outside the safe zone 101, and there is no or only small free space 110A or un-sufficient clearances 110B between the car 10 and the end of the shaft 12, for example, between the roof of the car 10 and the ceiling of the shaft 12 at the top of the shaft 12.

At the end of safe zone 101, there may be arranged an electrical limit 103, such as implemented by a limit switch device or software running in the elevator control unit 1000 using absolute position and speed and/or direction feedback from car 10. After the electrical limit 103, there may further be arranged a mechanical safety limit device 104, such as a detent attached to the shaft wall or to a stationary shaft structure for catching an extendable safety limit device 15 (schematically shown below the limit device 104 in FIG. 2), e.g. an arm in the car, defining a mechanical limit 104B, which may be pre-triggered by extending the extendable safety limit device 15 from the car 10 upon safe zone establishment after CTD or ROM detection indication.

Detection of e.g. operation of the emergency opening device of the lowest landing door 19A during elevator operation in normal operation mode would lead to an emergency stop and a corresponding safe zone arrangement at the lower end of the shaft 12. In this case, the non-safe zone 102 would be at the very bottom of the shaft 12 and the safe zone 101 would start from a height that leaves sufficient clearances between the bottom of the car 10 and shaft floor.

In some embodiments, the limit switch device can be used also for setting end of safe zone 101 during setup drive, such as during elevator commissioning, such as into the elevator control unit 1000, and after that safe zone 101 can be controlled and/or established by the absolute position device feedback.

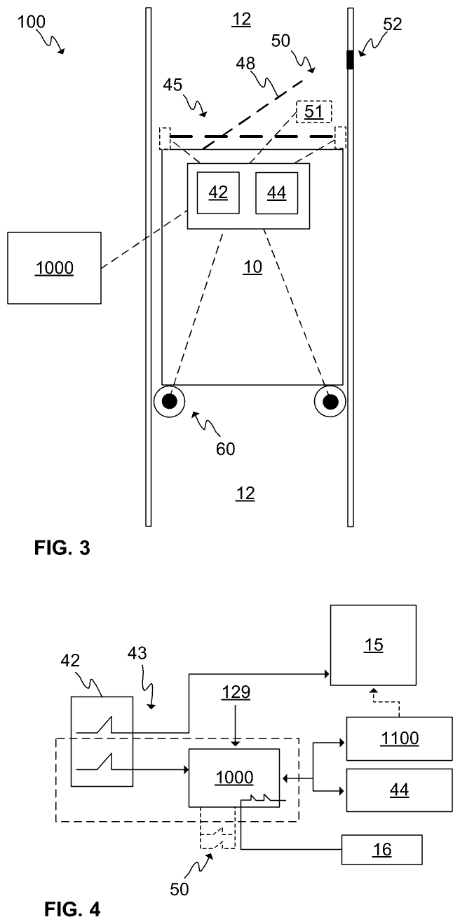

FIG. 3 illustrates schematically an elevator system 100 according to an embodiment of the present invention. FIG. 3 illustrates at least some components of the electrical safety control system in accordance with various embodiments of the present invention. The elevator system 100 may comprise, such as in the car 10 and/or the shaft 12, a detection system for detecting foreign objects on the car roof, such as a CTD or a ROM. The detection system 45 may comprise a detection sensor, such as based on, for example, curtain of light detection system. The detection system 45 may further comprise, in connection with the detection sensor, detection control device 42. FIG. 3 further illustrates an optional hatch 48 on top of the elevator car 10, via opening of which a service person, for instance, can climb to the roof of the car 10, that is into the elevator shaft 12. There may be a sensor arranged to monitor the position of the hatch 48, that is whether it is open or closed. The hatch 48 is open in FIG. 3.

The elevator system 100 may further comprise, such as in the car 10 and/or in the shaft 12, absolute car position and motion control system 44, which may include a position control unit and a position control sensor(s). This may preferably be a Safety Integrity Level 3 (SIL3) level car position, speed, and direction feedback system which may be controlled by the elevator control unit 1000. The elevator control unit 1000 is preferably arranged in at least communication connection with the absolute car position and motion control system 44 and/or the detection system 45, such as the detection control device 42 thereof. The elevator control unit 1000 may comprise a safety control unit.

Feedback from the car 10 can be provided from an absolute encoder or tachometer (located e.g. in guide shoe rollers, over speed governor (OSG), such as either onboard OSG or OSG in the shaft 12, or headroom with rope/belt linkage, or in diverter pulleys 60 or other type absolute positioning system (for example, optical bar belt reader). The safe zone mode in the elevator control unit 1000 may be set based on CTD presence detection indication by e.g. open CTD safety output or when car service access roof or cover open monitoring indicates detection of opening.

In some embodiments, the limit switch device can be used also for setting end of safe zone 101 during setup drive, such as during elevator commissioning, such as into the elevator control unit 1000, and after that safe zone 101 can be controlled and/or established by the absolute position device feedback. The limit switch device 50 may comprise a limit switch 51 and, optionally, a limit switch counterpart 52 arranged to the elevator shaft 12, such as to the guide rail 17 therein. The limit switch device 50 can be used as the reference for self-diagnostics of safe zone 101 in the electrical safety control system (cross-checking limit switch and absolute position system feedbacks).

As stated hereinbefore, in some embodiments, the electrical safety control system may comprise a limit switch device 50. The limit switch 51 may be based on a magnetic reader. The limit switch counterpart 52 may then be, for example, a magnet on limit position level. However, the limit switch 51 and its counterpart 52, if any, may be implemented in various other ways as well.

FIG. 4 shows a principle of electrical safety control for safe zone 101 according to an embodiment of the present invention. In the detection control device 42, there may be two separate safety outputs 43. One may be for a pre-triggering an extendable safety limit device 15. Another may be for 1) stopping elevator by safety circuit and 2) setting elevator on safe zone mode in the elevator control unit 1000. The control and/or establishing of the safe zone 101 may be based on both car absolute positioning and motion control system 44, and safe zone limit switch devices 50 as reference. Item 1100 in FIG. 4 refers to normal means for driving the elevator car 10, such as in relation to the elevator drive unit 35. Input 129 refers to reset of the electrical safety control system.

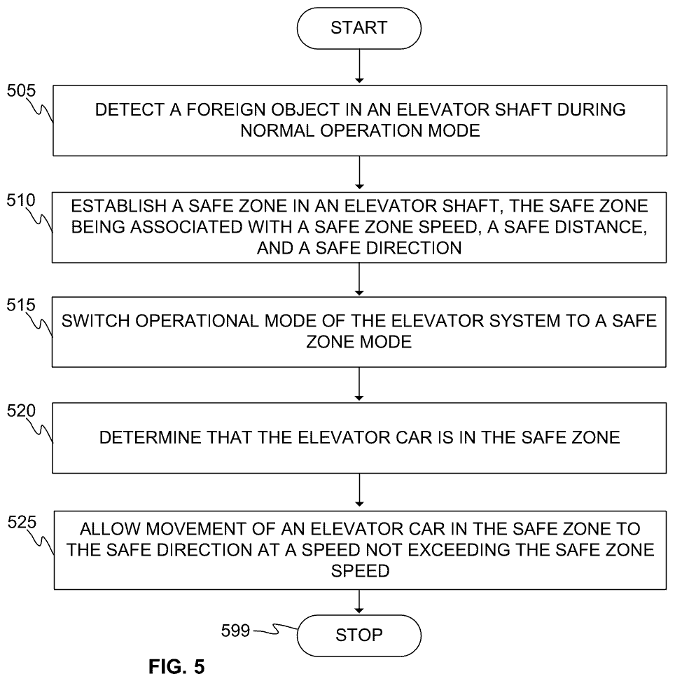

FIG. 5 shows a flow diagram of a method in accordance with an embodiment of the present invention.

Step 505 refers to detecting a foreign object in an elevator shaft 12 during normal operation mode. The foreign object may be a person or an animal which should not be present in the elevator shaft 12, that is elsewhere than inside the elevator car 10. Alternatively, the foreign object may be an open hatch leading into the elevator shaft 12, such as through a wall thereof or from the elevator car 10. The open hatch condition, for example, detected by a sensor monitoring the position of the hatch 48, indicates that there may be a person which has entered the elevator shaft 12, for instance.

Step 510 refers to establishing a safe zone 101 of the elevator shaft 12, wherein the safe zone 101 is associated with a safe zone speed, a safe distance, and a safe direction.

In various embodiments, the safe zone 101 may be established based on a position of the elevator car 10. Furthermore, the safe zone 101 may preferably include at least one landing 19 or landing position in the safe zone 101.

Step 515 refers to switching operational mode of the elevator system 100 to a safe zone mode, preferably, from the normal operation mode.

Alternatively or in addition, the safe zone 101 may be delimited by a mechanical safety limit device 104 arranged to the elevator shaft 12.

In some embodiments, a pre-triggered extendable safety limit device 15 may be arranged to prevent the car exiting the safe zone 101 at the direction of the shaft end that is closer to the car 10, such as towards the top or bottom end.

Step 520 refers to determining, prior to allowing movement, that the elevator car 10 is in the safe zone 101.

Step 525 refers to allowing movement of the elevator car 10 in the safe zone 101 to the safe direction at a speed not exceeding the safe zone speed.

In some embodiments, the method may comprise, after the allowing of the movement, automatically moving the elevator car 10 to the closest landing included in the safe zone 101. Still further, the method may comprise, after the automatic movement of the elevator car 10, opening elevator car doors, and/or landing floor doors when the elevator car 10 has reached the landing 19.

In some embodiments, the method may comprise, prior to allowing any movement, determining that the possible foreign object is not detected anymore. If the detection is active, the movement may not be allowed for as long as the detection is active. The movement may then be allowed once the detection no more indicates presence or has been reset or inactivated.

Method execution may be stopped at step 599. The elevator car 10 may now be moved in the safe zone, in the safe direction, for example, towards a landing 19 the elevator 100, such as the closest landing 19 relative to the current position of the elevator car 10.

In various embodiments, the method may comprise, prior to step 510, determining the elevator emergency condition, such as related to detecting an object in the elevator shaft and outside the elevator car 10.

The method may further comprise detecting a possible foreign object in the elevator shaft 12. The detection may, for example, be based on a sensor 42 detecting a foreign object outside the elevator car or a sensor detecting an open hatch condition of the elevator car, indicating a possible foreign object in the shaft 12 outside the car 10. Thus, the detection may be based on monitoring a status of a switch, such as normally open switch, or on a proximity sensor, curtain of light type optical detection system, floating detection platform plate with a safety switch detecting compression, or pressure sensitive detection carpet on the roof of the elevator car, or a safety switch detecting opening roof panels.

As stated hereinbefore, the elevator system 100 may comprise a detection system 45, such as CTD and typically also means for an immediate emergency stop, such as by the elevator control unit 1000. After the detection by the detection system 45, and possibly performing the emergency stop, the electrical safety control system switches on safe zone mode and enables the elevator system 100 to perform an automatic drive of the elevator car 10 with safe speed (e.g. 0.3 m/s) and within a safe distance to a safe direction to the closest landing 19. After that the elevator car 100 may be configured to open car doors and landing doors. Furthermore, the elevator car 10 may be stopped at the landing 19, such as landing door zone, as long as the detection of the detection system 45 is inactivated or reset in, preferably, a non-volatile or non-transitory, memory of electrical safety control system, such as in the elevator control unit 1000.

Before enabling the automatic drive (enabled by electrical safety control system but performed by elevator normal means 1100, such as by the elevator drive unit 35), the electrical safety control turns on safe-zone mode, wherein the elevator car 10 is allowed to move only with the safe speed and for at most the safe distance to the safe direction.

In some embodiments, before activating the safe zone mode, at least three steps may be performed as a checking sequence. First, determining if the elevator car 10 is at a landing 19. This may be based on door zone sensor and/or absolute position feedback. Second, determining if the detection system 45 is still active, e.g., if somebody or something is still potentially on the top of car 10. This may be performed, for example, based on SIL3 detection control device 42 and the detection sensor. Third, determining if the elevator car 10 is in the safe zone 101, such as based on SIL3 level position and movement feedback from car 44. By this it may be concluded that there is a sufficient free space and clearances available in the elevator shaft 12.

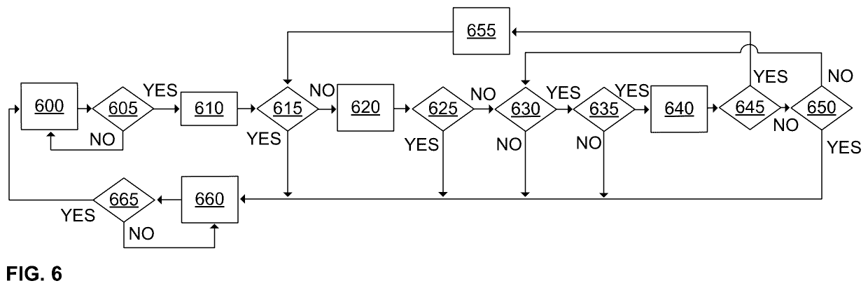

FIG. 6 shows a flow diagram of a method according to an embodiment of the present invention.

Item 600 refers to the elevator system 100 being in the normal operation mode.

Item 605 of FIG. 6 may refer to presence detection of the detection system, such as the CTD, that is related to a foreign object in the shaft 12, and opening safety circuit while elevator system 100, or single elevator of the elevator system 100, is running.

Item 610 may refer to switching the operational mode of the elevator to the safe zone mode.

Item 610 may include saving the activation of the detection into memory, preferably into a non-volatile memory (storage medium), of the elevator control unit 1000.

Item 610 may further include initiating an emergency stop of the elevator 100.

Item 610 may further include pre-triggering of an extendable safety limit device 15.

Item 615 may refer to determining if the detection system has indicated presence detection for a predetermined duration of time.

Item 620 may refer to waiting that the elevator car speed decreases under some speed limit, such as 1.0, 0.5, or 0.1 meters per second. That is, the system, or at least the control unit 1000, is arranged to monitor the speed and to have an idle or wait time period during which the speed of the elevator car 10 decreases or is waited to decrease.

Item 625 may refer to determining if the elevator car 10 is in a landing door zone, or in general at a landing so that the doors the elevator car 10 can be opened.

As visible in FIG. 6, if the elevator car 10 is determined to be in a landing door zone, or in general at a landing so that the doors the elevator car 10 can be opened, item 660, described hereinafter, may be directly performed.

Item 630 may refer to determining if the elevator car 10 is in safe zone 101. The elevator control unit 1000 may establish the position of the car 10 in relation to the shaft ends and, if the car 10 is not in breach of any required clearances, it may be considered to be in safe zone 101.

Item 635 may include determining if the extendable safety limit device 15 at the car is pre-triggered.

Item 640 may refer to moving the elevator car 10 with safe speed towards a landing, preferably the closest landing, in the safe zone 101 and in the safe direction by the elevator control unit 1000.

Item 645 may refer to determining, while moving the elevator car 10, whether the presence detection system indicates detection again.

Item 650 may refer to determining whether the elevator car 10 has reached a landing, continuing to determine if the elevator car 10 is still in safe zone 101 according to item 630.

Item 655 may refer to stopping the elevator car if presence detection is determined in 645.

Item 660 may refer to preventing car movement and operation mode change to normal operation if presence detection has been indicated by the presence detection system for a predetermined duration of time after item 610 or 655, or if the elevator car 10 is at a landing at items 625 or 650 or outside a safe zone at item 630, or if at item 635 it is determined that the extendable safety limit device 15 at the car has not been pre-triggered, until at item 665 a reset function is performed by a service person or technician, for example, manually at a maintenance panel, to cancel the safe zone mode after verification that there are no foreign objects in the shaft.

In response to and/or after the reset, the normal operation mode can be or is restored.

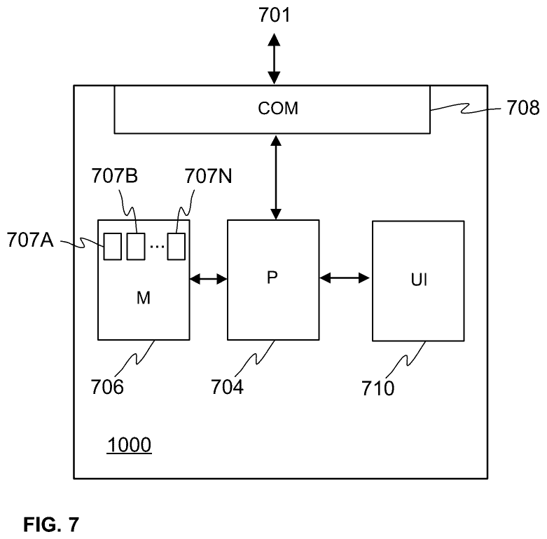

FIG. 7 illustrates schematically an elevator control unit 1000 according to an embodiment of the present invention. External units 701 may be connected to a communication interface 708 of the elevator control unit 1000. External unit 701 may comprise wireless connection or a connection by a wired manner. The communication interface 708 provides interface for communication with external units 701 such as the elevator car 10, the elevator drive unit 35, the brakes 16, the doors at the landings 19, and/or elevator car doors. There may also be connection to an external system, such as a laptop or a handheld device. There may also be a connection to a database of the elevator 1000 or an external database including information used in controlling the operation of the elevator 1000.

The elevator control unit 1000 may comprise one or more processors 704, one or more memories 706 being volatile or non-volatile, or non-transitory, for storing portions of computer program code 707A-707N and any data values and possibly one or more user interface units 710. The mentioned elements may be communicatively coupled to each other with e.g. an internal bus.

The processor 704 of the elevator control unit 1000 is at least configured to implement at least some method steps as described hereinbefore. The implementation of the method may be achieved by arranging the processor 704 to execute at least some portion of computer program code 707A-707N stored in the memory 706 causing the processor 704, and thus the elevator control unit 1000, to implement one or more method steps as described. The processor 704 is thus arranged to access the memory 706 and retrieve and store any information therefrom and thereto. For sake of clarity, the processor 704 herein refers to any unit suitable for processing information and control the operation of the elevator control unit 1000, among other tasks. The operations may also be implemented with a microcontroller solution with embedded software. Similarly, the memory 706 is not limited to a certain type of memory only, but any memory type suitable for storing the described pieces of information may be applied in the context of the present invention.

1. A method for ensuring elevator safety in an elevator system, the method comprising:
detecting a foreign object in an elevator shaft during normal operation mode,
establishing a safe zone of an elevator shaft of the elevator system, wherein the safe zone is associated with a safe zone speed, a safe distance, and a safe direction,
switching operational mode of the elevator system to a safe zone mode,
determining that the elevator car is in the safe zone, and
allowing movement of the elevator car in the safe zone to the safe direction at a speed not exceeding the safe zone speed.

2. The method of claim 1, wherein the safe zone is established based on a position of the elevator car.

3. The method of claim 1, wherein the safe zone includes at least one landing in the safe zone.

4. The method of claim 1, wherein the safe zone speed is equal to or less than the elevator's maintenance mode or correction drive speed, the safe direction is away from the direction in which detection of a foreign object or an open car hatch has been indicated and the safe distance is that between the car and a landing that is closest in the safe direction.

5. The method of claim 4, wherein the detection of the foreign object is based on a sensor indicating a foreign object outside the elevator car or based on a sensor indicating an open hatch condition of the elevator car.

6. The method of claim 1, wherein the safe zone is delimited by a limit switch device arranged to the elevator shaft.

7. The method of claim 1, wherein a mechanical safety limit device is arranged to prevent the elevator car moving in the direction towards the shaft end upon or after exiting the safe zone.

8. The method of claim 1, comprising pre-triggering an extendable safety limit device in response to the switching the operational mode of the elevator to the safe zone mode.

9. The method of claim 1, comprising, after allowing movement, automatically moving the elevator car to a landing in the safe zone that is closest to the elevator car.

10. The method of claim 9, further comprising, after the automatically moving, opening of elevator car doors.

11. The method of claim 1, comprising, prior to the allowing movement, determining that there is no more indication of a foreign object in the elevator shaft or open hatch condition of the elevator car.

12. An elevator control unit comprising
at least one processor and at least one memory storing at least one portion of computer program code, wherein the elevator control unit is configured to control movement of an elevator car, wherein
the elevator control unit is configured to perform a method of claim 1.

13. An elevator system comprising at least one elevator car, each one of the at least one elevator car movable in a corresponding elevator shaft, and at least two landings, wherein the elevator system comprises the elevator control unit of claim 12.

14. The elevator system of claim 13, wherein the elevator shaft is arranged to comprise a low top and/or a low pit.

15. A non-transitory computer readable medium storing a computer program comprising program instructions which when executed by an elevator control unit cause the elevator control unit to perform the method according to claim 1.

16. The method of claim 2, wherein the safe zone includes at least one landing in the safe zone.

17. The method of claim 2, wherein the safe zone speed is equal to or less than the elevator's maintenance mode or correction drive speed, the safe direction is away from the direction in which detection of a foreign object or an open car hatch has been indicated and the safe distance is that between the car and a landing that is closest in the safe direction.

18. The method of claim 3, wherein the safe zone speed is equal to or less than the elevator's maintenance mode or correction drive speed, the safe direction is away from the direction in which detection of a foreign object or an open car hatch has been indicated and the safe distance is that between the car and a landing that is closest in the safe direction.

19. The method of claim 2, wherein the safe zone is delimited by a limit switch device arranged to the elevator shaft.

20. The method of claim 3, wherein the safe zone is delimited by a limit switch device arranged to the elevator shaft.
